(19) United States
(12) Patent Application Publication
(10) Pub. No.: US 2025/0262610 A1
(43) Pub. Date: Aug. 21, 2025

(54) METHOD OF PREPARING CATALYST FOR AMMONIA DECOMPOSITION

(71) Applicant: SK INNOVATION CO., LTD., Seoul (KR)

(72) Inventors: Jae Suk CHOI, Daejeon (KR); Jong Baek SUNG, Daejeon (KR); Seung Woo LEE, Daejeon (KR); Ju Hwan IM, Daejeon (KR)

(21) Appl. No.: 19/055,395

(22) Filed: Feb. 17, 2025

(30) Foreign Application Priority Data
Feb. 16, 2024 (KR) 10-2024-0022493

(51) Int. Cl. B01J 23/63; B01J 21/04; B01J 35/45; B01J 35/70; B01J 37/08; B01J 37/18

(52) U.S. Cl. CPC B01J 23/63; B01J 21/04; B01J 35/45; B01J 35/733; B01J 37/08; B01J 37/18

(57) ABSTRACT

According to the embodiments of the present disclosure, an ammonia decomposition catalyst may be prepared by performing heat treatment on alumina, a lanthanum compound and a cerium compound in a reducing gas atmosphere to form a composite oxide on an alumina support, and supporting an active metal including ruthenium on the composite oxide.

### CROSS-REFERENCE TO RELATED APPLICATION(S)

This application claims priority under 35 U.S.C. § 119 to Korean Patent Application No. 10-2024-0022493, filed on Feb. 16, 2024, the disclosure of which is incorporated herein by reference in its entirety.

### BACKGROUND

### 1. Field of the Invention

The embodiments of the present disclosure relate generally to ammonia decomposition technology and, more particularly, to a method of preparing a catalyst for ammonia decomposition referred to hereinafter also as an ammonia decomposition catalyst.

### 2. Description of the Related Art

Due to increased environmental pollution concerns, demand is increasing for renewable alternative energy (RAE) to replace fossil fuels such as petroleum and coal.

Hydrogen may serve as a RAE. A material capable of efficiently storing and transporting hydrogen is ammonia (NH₃). For example, hydrogen may be extracted by using a reaction in which ammonia (NH₃) is decomposed into hydrogen (H₂) and nitrogen (N₂).

However, the process of decomposing ammonia into hydrogen and nitrogen is an endothermic process, requiring a large amount of heat and energy. Therefore, when obtaining hydrogen gas through the ammonia decomposition reaction, the amount of heat and energy consumed may increase. To obtain high-purity hydrogen with high efficiency, an ammonia decomposition catalyst may be used.

An ammonia decomposition catalyst decomposes ammonia at a lower temperature and may use an active metal such as a transition metal including nickel or iron, etc., or a platinum metal including palladium or ruthenium, etc. Among the active metals used, the platinum metal has high activity for the ammonia decomposition reaction, but it is rare and expensive compared to the transition metals such as nickel or iron, which may decrease the workability and economic advantages.

In addition, research is being carried out to develop an ammonia decomposition catalyst that can decompose ammonia with high efficiency at low costs by preventing aggregation of the metal particles when metal particles are included in a support of the ammonia decomposition catalyst.

### SUMMARY

An embodiment of the present disclosure provides a method of preparing an ammonia decomposition catalyst with improved dispersibility.

In a method of preparing a catalyst for ammonia decomposition according to embodiments of the present disclosure, by performing heat treatment on alumina, a lanthanum compound and a cerium compound in a reducing gas atmosphere including hydrogen, a composite oxide may be formed on an alumina support. An active metal including ruthenium may be supported on the composite oxide.

In some embodiments of the present disclosure, the active metal may further include a promoter including at least one of cesium (Cs), sodium (Na), potassium (K), lithium (Li), rubidium (Rb), francium (Fr), barium (Ba), calcium (Ca), strontium (Sr), beryllium (Be) and magnesium (Mg).

In some embodiments of the present disclosure, the composite oxide may be formed by performing heat treatment on the alumina, the lanthanum compound and the cerium compound at a temperature of greater than 600° C. and 1,000° C. or lower.

In some embodiments of the present disclosure, the composite oxide may be formed by performing heat treatment on the alumina, the lanthanum compound and the cerium compound at a temperature of 900° C. to 1,000° C.

In some embodiments of the present disclosure, the reducing gas may include hydrogen in an amount of 10% by volume to 100% by volume based on a total volume of the reducing gas.

In some embodiments of the present disclosure, the composite oxide may contain lanthanum, cerium and aluminum.

In some embodiments of the present disclosure, the composite oxide may be formed by doping lanthanum derived from the lanthanum compound and cerium derived from the cerium compound on a surface of the alumina.

In some embodiments of the present disclosure, the alumina support may include Al₂O₃.

In some embodiments of the present disclosure, the composite oxide may have a perovskite structure.

In some embodiments of the present disclosure, a ratio of the perovskite structure in a crystal structure of the composite oxide may be 5% to 99%.

In some embodiments of the present disclosure, the active metal including ruthenium may be supported on the composite oxide by mixing the composite oxide and the active metal including ruthenium, and performing heat treatment.

In some embodiments of the present disclosure, a heat treatment temperature on the composite oxide and the active metal may be lower than a heat treatment temperature on the alumina, the lanthanum compound and the cerium compound.

In some embodiments of the present disclosure, the heat treatment temperature on the composite oxide and the active metal may be 200° C. to 1,000° C.

In some embodiments of the present disclosure, the heat treatment temperature on the composite oxide and the active metal may be 400° C. to 800° C.

In some embodiments of the present disclosure, the process of supporting an active metal including ruthenium on the composite oxide may be performed in a reducing gas atmosphere.

In some embodiments of the present disclosure, a content of ruthenium supported on the composite oxide may be less than 1.5% by weight based on a total weight of the composite oxide and the active metal.

In some embodiments of the present disclosure, the content of ruthenium supported on the composite oxide may be 0.1% by weight to 1.3% by weight based on the total weight of the composite oxide and the active metal.

According to the embodiments of the present disclosure, a composite oxide may be formed from alumina, a lanthanum compound and a cerium compound in a reducing gas atmosphere. The composite oxide may have a perovskite crystal structure. Thus, the dispersibility of the active metal in the composite oxide may be improved, and the amount of the active metal used and the heat treatment temperature may be decreased.

Therefore, exposure of the active metal at a high temperature may be suppressed, thereby improving the dispersion of the active metal in the composite oxide. Accordingly, the dispersion of the active metal is improved, such that ammonia may be decomposed with a relatively low content to obtain high-purity hydrogen.

### BRIEF DESCRIPTION OF THE DRAWINGS

The above and other objects, features and advantages of the embodiments of the present disclosure will be more clearly understood from the following detailed description taken in conjunction with the accompanying drawings, in which:

FIG. 1 is a schematic process flowchart for describing a method of preparing an ammonia decomposition catalyst according to embodiments of the present disclosure; and

FIG. 2 is an X-ray diffraction graph of composite oxides according to embodiments of the present disclosure.

### DETAILED DESCRIPTION

According to embodiments of the present disclosure, a method of preparing an ammonia decomposition catalyst is provided.

Hereinafter, embodiments of the present disclosure will be described in more detail. However, the following drawings attached to the present specification illustrate embodiments of the present disclosure, and serve to further understand the technical concepts of the present disclosure together with the above-described contents of the embodiments. Hence, the embodiments of the present disclosure should not be construed as being limited only to the illustrations of the drawings.

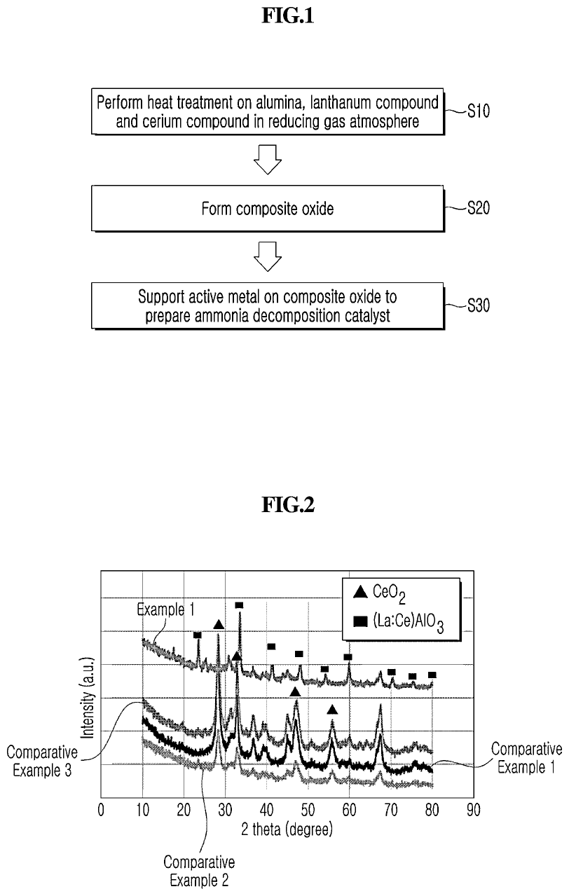

FIG. 1 is a schematic process flowchart for describing a method of preparing an ammonia decomposition catalyst according to embodiments of the present disclosure.

Referring to FIG. 1, heat treatment may be performed on alumina, a lanthanum compound and a cerium compound in a reducing gas atmosphere (e.g., operation S10).

In some embodiments of the present disclosure, the lanthanum compound may use at least one of lanthanum metal or a nitrate, an oxide, a chloride, a bromide, a fluoride, a hydroxide, a carbonate, an acetate, a sulfate, a carbonate, a naphthenate, an isopropoxide and an organometallic complex of lanthanum. These may be used alone or in combination of two or more thereof.

In some embodiments of the present disclosure, the lanthanum compound may include lanthanum nitrate. The lanthanum nitrate may be decomposed, preferably completely decomposed, in the heat treatment process, such that no residue may remain on the catalyst. Therefore, there is no need to perform a subsequent process for removing the nitrate, and thereby the process efficiency may be improved. Hence the inventive process is economically advantageous. For example, the nitrate may be supplied in large quantities thus significantly reducing catalyst production costs.

In some embodiments of the present disclosure, the cerium compound may include at least one of cerium metal and a nitrate, an oxide, a chloride, a bromide, a fluoride, a hydroxide, a carbonate, an acetate, a sulfate, a carbonate, a naphthenate, an isopropoxide and an organometallic complex of cerium. These cerium compounds may be used alone or in combination of two or more thereof.

In some embodiments of the present disclosure, the cerium compound may include cerium nitrate. The cerium nitrate may be completely decomposed in the heat treatment process, such that no residue may remain on the catalyst. Therefore, there is no need to perform a subsequent process for removing the nitrate thus improving the process efficiency and rendering the process economically advantageous over existing processes. For example, the cerium nitrate may be supplied in large quantities, such that the economic advantages in terms of the catalyst production costs may be improved.

In some embodiments of the present disclosure, the alumina support may include Al₂O₃ for improved stability at the operation temperature of the ammonia decomposition catalyst. Therefore, the dispersion of the ammonia catalyst may be improved by the alumina support.

In some embodiments of the present disclosure, the alumina support may include alpha-alumina (α-Al₂O₃), beta-alumina (β-Al₂O₃), delta-alumina (δ-Al₂O₃), eta-alumina (η-Al₂O₃) and/or theta-alumina (θ-Al₂O₃).

According to some embodiments, the alumina, the lanthanum compound and the cerium compound may be subjected to heat treatment to form an alumina support and a composite oxide (e.g., operation S20).

For example, the alumina support may be formed from a portion of the alumina by the heat treatment process. In addition, lanthanum and cerium may be doped on the surface of the alumina to form a composite oxide including aluminum, lanthanum and cerium on the alumina support.

Lanthanum-cerium oxide supported on alumina is generally reported to have a cubic structure similar to that of cerium oxide (CeO₂) (Catalysis Today, Vol. 158, pp. 348). Under general oxidation conditions, cerium does not undergo a structural transition to a perovskite structure upon high-temperature heat treatment.

According to embodiments of the present disclosure, the composite oxide may have a perovskite structure. For example, the alumina, the lanthanum compound and the cerium compound may be subjected to heat treatment in a reducing gas atmosphere, such that lanthanum and cerium may be dissolved in the alumina to form a perovskite crystal structure.

Perovskite has a three-dimensional crystal structure formed by combining two types of cations and one type of anion, and may mean the same type of a crystal structure as the crystal structure of calcium titanium oxide (CaTiO₃). For example, perovskite may have a general formula such as ABX₃ or ABCX₃, and in the general formula, X atoms are located at a center of each crystal plane.

Since the composite oxide has a perovskite structure, high-temperature stability of the composite oxide may be improved. In addition, an active metal such as a transition metal may be more easily supported or doped in the composite oxide even at a relatively low temperature.

When the metal compound includes cerium, etc., the composite oxide having a perovskite structure may not be smoothly formed under heat treatment conditions such as an ambient atmosphere, an inert atmosphere or an oxygen atmosphere. For example, when performing heat treatment on the above-described metal compounds in an inert atmosphere or an ambient atmosphere, the composite oxide formed therefrom may have a mixed oxide structure of lanthanum-cerium composite oxide and alumina in a high ratio among the crystal structures. For example, the mixed oxide may mean a solid solution of heterogeneous metal oxides.

When the active metal (e.g., ruthenium) and the composite oxide are subjected to heat treatment together while the composite oxide has a mixed oxide structure, doping or supporting of the active metal into the composite oxide may be hindered. Accordingly, the dispersion of the active metal in the composite oxide may be decreased.

According to some embodiments, the composite oxide may have a perovskite structure, such that the dispersibility of the active metal in the composite oxide may be improved.

In some embodiments of the present disclosure, a ratio of the perovskite structure in the crystal structure of the composite oxide may be 5% to 99%. Within the above range, a high ratio of active sites for the active metal may be provided. In addition, high selectivity for the ammonia decomposition catalyst may be provided to reduce formation of byproducts and to obtain high-purity hydrogen.

For example, the content of metal oxide crystal mixtures may be quantified through calibration based on XRD analysis using internal standards or through XRD peak analysis, such as the Rietveld refinement method. Additionally, the Data Processing Tool provided by the XRD measurement equipment may be utilized.

In some embodiments of the present disclosure, the reduction treatment of the alumina, the lanthanum compound and the cerium compound may include using a reducing gas such as hydrogen, carbon monoxide, hydrocarbon, and the like.

In some embodiments of the present disclosure, hydrogen may be used as the reducing gas. In some embodiments of the present disclosure, the reducing gas may be used diluted with nitrogen or carbon dioxide.

In some embodiments of the present disclosure, the reducing gas may include hydrogen in an amount of 10% by volume (“vol %”) to 100 vol % based on a total volume of the reducing gas. Within the above range, a ratio of the perovskite structure in the crystal structure of the composite oxide may be increased. Accordingly, the dispersibility of the active metal in the composite oxide may be further improved.

In some embodiments of the present disclosure, the reducing gas may include hydrogen in an amount of 90 vol % to 100 vol %, or 99 vol % to 100 vol % based on the total volume of the reducing gas. For example, the reducing gas may be composed of 99.9 vol % or 100 vol % of hydrogen gas.

In some embodiments of the present disclosure, a heat treatment temperature on the alumina, the lanthanum compound and the cerium compound may be greater than 600° C. For example, the heat treatment temperature may be greater than 600° C. and 1,200° C. or lower, greater than 600° C. and 1,000° C. or lower, 800° C. to 1,000° C., or 850° C. to 1,000° C.

In the reducing gas atmosphere including hydrogen, the higher the heat treatment temperature on the alumina, the lanthanum compound and the cerium compound within the above-described range, the higher the ratio of the perovskite structure in the crystal structure of the composite oxide.

For example, by performing heat treatment on the lanthanum compound and the cerium compound at a temperature of 900° C. or higher under a reducing gas atmosphere including 99.9 vol % or 100 vol % of hydrogen gas, the ratio of the perovskite structure in the crystal structure of the composite oxide may be formed to be 80% to 99%, or 90% to 99%.

In some embodiments of the present disclosure, the heat treatment time may be 1 hour to 10 hours, 3 hours to 8 hours, or 4 hours to 6 hours.

In some embodiments of the present disclosure, the alumina support may function as a support or base layer of the ammonia catalyst. For example, a mechanical strength of the alumina catalyst may be improved as the support of the ammonia catalyst.

In some embodiments of the present disclosure, the composite oxide may further contain other rare earth metals in addition to the lanthanum and cerium. For example, the rare earth metal-containing compound may be subjected to heat treatment together with the alumina, the lanthanum compound and the cerium compound.

In some embodiments of the present disclosure, the rare earth metal may include at least one of scandium (Sc), yttrium (Y), neodymium (Nd), samarium (Sm), gadolinium (Gd) and ytterbium (Yb).

These may be included alone or in combination of two or more thereof. In some embodiments of the present disclosure, the rare earth metal-containing compound may include at least one of an oxide, a chloride, a bromide, a fluoride, a hydroxide, a carbonate, an acetate, a sulfate, a nitrate, a carbonate, a naphthenate, an isopropoxide and an organometallic complex of the rare earth metal. These may be used alone or in combination of two or more thereof.

In some embodiments of the present disclosure, a molar ratio of cerium to lanthanum in the composite oxide may be 0.1 to 10, 0.2 to 5, or 0.3 to 3. Within the above range, an ammonia decomposition speed may be improved, and an ammonia conversion rate at a low temperature may be further improved.

According to embodiments of the present disclosure, an active metal may be supported on the composite oxide (e.g., step S30). The active metal may be supported on the composite oxide to prepare an ammonia decomposition catalyst.

For example, the active metal may promote ammonia decomposition as an active component of the ammonia decomposition catalyst.

According to embodiments of the present disclosure, the active metal may include an active catalyst.

According to embodiments of the present disclosure, the active catalyst may include a transition metal and/or platinum metal, and for example, at least one of metals belonging to groups 8 to 10 in the periodic table.

In some embodiments of the present disclosure, the active catalyst may include osmium (Os), nickel (Ni), iron (Fe), cobalt (Co), platinum (Pt), palladium (Pd), ruthenium (Ru), vanadium (V), copper (Cu), chromium (Cr), tungsten (W), molybdenum (Mo), iridium (Ir), rhodium (Rh), zirconium (Zr), and the like.

In some embodiments of the present disclosure, the ammonia decomposition catalyst may include a platinum metal as the active metal. The platinum metal has high ionization tendency thus provides high activity in oxidation/reduction reactions, and thereby the decomposition speed and conversion rate of ammonia may be further improved.

For example, the ammonia decomposition catalyst may include ruthenium as the active metal. Ruthenium has strong catalytic activity, such that a dehydrogenation decomposition reaction of ammonia and catalytic activity may be further improved.

According to some embodiments, the active metal of the ammonia decomposition catalyst may further include a promoter as a cocatalyst. The promoter may include an alkali metal and/or alkaline earth metal, and for example, at least one of the metals belonging to group 1 to group 2 in the periodic table.

In some embodiments of the present disclosure, the promoter may include cesium (Cs), sodium (Na), potassium (K), lithium (Li), rubidium (Rb), francium (Fr), barium (Ba), calcium (Ca), strontium (Sr), beryllium (Be) and magnesium (Mg). These may be included alone or in combination of two or more thereof.

In some embodiments of the present disclosure, the promoter may include an alkali metal. An alkali metal element may include one electron in the outermost electron shell thereof and thus may act as an electron donor. In addition, the alkali metal element may increase the active site on the surface of the active catalyst, thereby suppressing aggregation of the active catalyst, and further improving the dispersion of the active catalyst. Accordingly, the alkali metal may further improve the promotion of the active catalyst in the chemical reaction as the promoter.

In some embodiments of the present disclosure, the composite oxide and the active metal compound may be subjected to heat treatment. For example, the active metal compound may be added to or mixed with the composite oxide, followed by performing heat treatment. Due to the heat treatment, the active metal derived from the active metal compound may be supported or doped in the composite oxide.

In some embodiments of the present disclosure, the active metal compound may use at least one of a nitrate, an oxide, a chloride, a bromide, a fluoride, a hydroxide, a carbonate, an acetate, a sulfate, a carbonate, a naphthenate, an isopropoxide and an organometallic complex of the active metal. These may be used alone or in combination of two or more thereof.

In some embodiments of the present disclosure, the heat treatment temperature on the composite oxide and the active metal compound may be 1,000° C. or lower or 900° C. or lower, and 200° C. or higher or 400° C. or higher. Within the above range, the activity and stability of the catalyst may be further enhanced.

In some embodiments of the present disclosure, the heat treatment temperature on the composite oxide and the active metal compound may be 600° C. or lower. For example, the heat treatment temperature may be 200° C. to 600° C., or 400° C. to 600° C. When the heat treatment temperature is 600° C. or lower, the aggregation of the active metal due to the high temperature may be suppressed, and activity of the catalyst may be further improved. When the heat treatment temperature is 200° C. or higher, the metal may be sufficiently activated, such that performance of the ammonia decomposition catalyst may be improved.

In some embodiments of the present disclosure, the heat treatment temperature on the composite oxide and the active metal compound (e.g., the heat treatment temperature in operation S30) may be lower than the heat treatment temperature of the alumina, the lanthanum compound and the cerium compound (e.g., the heat treatment temperature in operation S10). For example, the active metal may be supported on the composite oxide having a perovskite structure, to prepare an ammonia decomposition catalyst having a perovskite structure without an additional crystallization process after supporting the active metal. Accordingly, the active metal may be supported at a relatively low temperature, such that sintering of the active metal due to the high temperature may be prevented, and the dispersion and usage rate of the active metal may be improved.

In some embodiments of the present disclosure, the process of supporting the active metal on the composite oxide may be performed in a reducing gas atmosphere. For example, the composite oxide and the active metal compound may be subjected to heat treatment in the reducing gas atmosphere.

In some embodiments of the present disclosure, the reduction treatment of the composite oxide and the active metal compound may include using a reducing gas such as hydrogen, carbon monoxide, or hydrocarbon, or a method adding a reducing agent such as hydrogen peroxide, hydrogen sulfide, lithium aluminum hydride, or lithium borohydride, and the like.

In some embodiments of the present disclosure, the composite oxide and the active metal compound may be subjected to heat treatment in a reducing gas atmosphere, for example, in a hydrogen atmosphere.

In some embodiments of the present disclosure, the reducing gas may be used by diluting it with nitrogen or carbon dioxide.

In some embodiments of the present disclosure, the reducing gas may include 10 to 100 vol % of hydrogen based on the total volume of the reducing gas. Accordingly, the dispersibility of the active metal in the composite oxide may be further improved.

In some embodiments of the present disclosure, the reducing gas may include 90 vol % to 100 vol %, or 99 vol % to 100 vol % of hydrogen based on the total volume of the reducing gas. For example, the reducing gas may be composed of 99.9 vol % or 100 vol % of hydrogen gas.

In some embodiments of the present disclosure, a content of the active catalyst supported on the composite oxide may be 1.6% by weight (“wt %”) or less, 1.5 wt % or less, or less than 1.5 wt % based on a total weight of the composite oxide and the active catalyst.

In some embodiments of the present disclosure, the content of the active catalyst supported on the composite oxide may be 0.1 wt %0 to 1.3 wt %, 0.15 wt % to 1.25 wt %, 0.2 wt %, 0 to 1.0 wt %, or 0.5 wt % to 0.8 wt % based on the total weight of the composite oxide and the active catalyst.

In some embodiments of the present disclosure, the content of the promoter may be 0.5 wt % to 6 wt % based on the total weight of the composite oxide and the active metal. Within the above range, the activity of the ammonia decomposition catalyst may be further enhanced.

According to some embodiments of the present disclosure, the active metal may be supported in the composite oxide having a perovskite crystal structure, such that the dispersibility may be improved even if the content of the active metal is small. Therefore, an amount of the active metal used may be reduced, and an ammonia decomposition catalyst having high efficiency may be prepared at low cost.

In some embodiments of the present disclosure, when the content of the active catalyst is 0.1 wt % or more, the active site of the ammonia decomposition catalyst may be further increased. Therefore, the activity of the ammonia decomposition catalyst may be enhanced, thereby improving the decomposition speed and conversion rate of ammonia.

In some embodiments of the present disclosure, the composite oxide may include a compound represented Formula 1 below.

LaₓCe₁₋ₓAlO₃ Formula 1

In Formula 1 above, x may be in a range of 0.05<x≤0.95.

In some embodiments of the present disclosure, in Formula 1 above, x may be in a range of 0.2<x≤0.85, for example, 0.4<x≤0.8, or 0.45<x≤0.75. When contents of La and Ce are within the above range, the ammonia decomposition activity may be further improved, and the catalyst may have a high ammonia conversion rate even at a low temperature.

In some embodiments of the present disclosure, the composite oxide may be formed by doping lanthanum derived from the lanthanum compound and cerium derived from the cerium compound on the surface of the alumina.

In some embodiments of the present disclosure, the composite oxide may be formed by doping the lanthanum and the cerium on the surface of the alumina. For example, the lanthanum and the cerium may be uniformly dispersed in the alumina to be doped thereon.

In some embodiments of the present disclosure, the lanthanum and the cerium doped in the alumina may have a form of nanoparticles. For example, the lanthanum and the cerium may have a form of nanoparticles with a diameter of 1 nm to 500 nm. The diameter of the above particles can be measured, for example, using a high-resolution transmission electron microscope.

In some embodiments of the present disclosure, the oxides formed as the composite oxide on the alumina support may further include other rare earth metals in addition to the lanthanum and cerium. For example, the oxides may include at least one of scandium (Sc), yttrium (Y), neodymium (Nd), samarium (Sm), gadolinium (Gd) and ytterbium (Yb). These may be included alone or in combination of two or more thereof.

The ammonia decomposition catalyst according to embodiments of the present disclosure may include an alumina support, a composite oxide formed on the alumina support, and an active metal including ruthenium supported on the composite oxide.

The composite oxide may include lanthanum, cerium and aluminum. For example, the composite oxide may be a metal oxide formed by dissolving lanthanum, cerium and aluminum together.

According to some embodiments of the present disclosure, a content of the ruthenium may be less than 1.5 wt % based on the total weight of the composite oxide and the active metal.

In some embodiments of the present disclosure, the content of the ruthenium supported on the composite oxide may be 0.1 wt % to 1.3 wt %, 0.15 wt % to 1.25 wt %, 0.2 wt % to 1.0 wt %, or 0.5 wt % to 0.8 wt % based on the total weight of the composite oxide and the active metal.

According to embodiments of the present disclosure, the active metal may further include a promoter. The above-described promoter may include an alkali metal and/or an alkaline earth metal.

In some embodiments of the present disclosure, the composite oxide may have a perovskite structure. As the composite oxide has the perovskite structure, the high-temperature stability and catalytic activity of the ammonia catalyst may be further improved, and the dispersibility of the active metal in the composite oxide may be improved.

In some embodiments of the present disclosure, the ratio of the perovskite structure in the crystal structure of the composite oxide may be 5% to 99%. Within the above range, a high ammonia conversion rate may be obtained even at a low temperature due to the electronic contribution effect to the active metal.

Hereinafter, embodiments of the present disclosure will be further described with reference to specific preparative examples. Examples and comparative examples included in the preparative examples only illustrate the embodiments and are not intended to limit the appended claims. It will be apparent to those skilled in the art that various alterations and modifications are possible within the scope and technical concepts of the present disclosure, and such alterations and modifications are duly included in the appended claims. Furthermore, the embodiments may be combined to form additional embodiments.

### Preparative Example: Composite Oxide on Alumina Support

### (1) Example

### 1) Preparation of Composite Oxide

10 g of alumina, 2.85 g of lanthanum nitrate hydrate (99%, Sigma), and 2.70 g of cerium nitrate hydrate (99%, Sigma) were added to deionized water, and mixed at room temperature to prepare an aqueous solution.

The aqueous solution was dried at room temperature, and a first heat treatment was performed at 900° C. for 4 hours in a 100% hydrogen atmosphere to prepare an alumina support and a lanthanum-cerium-alumina-containing composite oxide formed on the alumina support.

### 2) Preparation of Ammonia Catalyst

An ammonia catalyst precursor was prepared by impregnating ruthenium nitrosyl nitrate as a ruthenium compound into 1 g of the composite oxide. The ruthenium compound was added so that a content of ruthenium (Ru) was 0.8 wt % based on the total weight of the composite oxide and ruthenium.

The ammonia catalyst precursor was dried, and a second heat treatment was performed at a temperature of 600° C. for 4 hours in a 100% hydrogen atmosphere to prepare an ammonia decomposition catalyst.

### (2) Comparative Examples 1 to 3

A lanthanum-cerium-alumina-containing composite oxide was formed in the same manner as in Example 1, except that the heat treatment conditions in the composite oxide formation step were changed as listed in Table 1 below.

TABLE 1

| | First heat treatment | First heat treatment |
|---|---|---|
| | atmosphere | temperature (° C.) |
| Example 1 | 100 vol % hydrogen | 900 |
| Comparative Example 1 | 100 vol % ambient | 500 |
| Comparative Example 2 | 100 vol % helium | 900 |
| Comparative Example 3 | 100 vol % ambient | 900 |

### (3) Measurement of Composite Oxide Crystals

Before preparing the ammonia catalyst, crystal structures of the composite oxides prepared in Example 1 and Comparative Examples 1 to 3 were measured.

FIG. 2 is an XRD graph of the composite oxides of the examples and comparative examples. In FIG. 2, □ is a peak of a crystal structure of perovskite (LaCeAlO₃), and Δ is a peak of a crystal structure of CeO₂.

Referring to FIG. 2, it can be observed that unique diffraction peaks (32.9° and 23.4°) of the perovskite (LaCeAlO₃) are formed significantly in Example 1.

In Comparative Examples 1 to 3, it can be observed that unique diffraction peaks (28.3° and 32.8°) of the cerium oxide (CeO₂) mixed oxide are formed significantly.

### (4) Examples 1 to 4, and Comparative Examples 4 to 8

In the examples and comparative examples, ammonia decomposition catalysts were prepared in the same manner as in Example 1, except that the first heat treatment temperature, the second heat treatment temperature and the ruthenium content were changed as listed in Table 2 below.

In the comparative examples, ammonia decomposition catalysts were prepared in the same manner as in Example 1, except that the first heat treatment conditions, the second heat treatment conditions and the ruthenium content were changed as listed in Table 2 below.

In Table 2 below, the ruthenium content (wt %) was calculated Equation 1 below.

$$Ruthenium content ( wt \% ) = \qquad Equation 1$$

$$[ Ruthenium content ( weight ) included in ruthenium compound /$$

$$\{ Content ( weight ) of composite oxide +$$

$$Ruthenium content ( weight ) included in ruthenium compound \} ] \times 100$$

TABLE 2

| | | First | | Second |
|---|---|---|---|---|
| | | heat | | heat |
| | | treatment | | treatment |
| | | tempera- | Ruthenium | tempera- |
| | First heat treatment | ture | content | ture |
| | atmosphere | (° C.) | (wt %) | (° C.) |
| Example 1 | 100 vol % hydrogen | 900 | 0.8 | 600 |
| Example 2 | 100 vol % hydrogen | 900 | 0.8 | 900 |
| Example 3 | 100 vol % hydrogen | 900 | 1.5 | 900 |
| Example 4 | 100 vol % hydrogen | 600 | 1.5 | 600 |
| Comparative | 100 vol % ambient | 900 | 1.6 | 300 |
| Example 4 | | | | |
| Comparative | 100 vol % ambient | 900 | 1.6 | 500 |
| Example 5 | | | | |
| Comparative | 100 vol % ambient | 900 | 1.6 | 600 |
| Example 6 | | | | |
| Comparative | 100 vol % ambient | 900 | 1.6 | 700 |
| Example 7 | | | | |
| Comparative | 100 vol % ambient | 900 | 1.6 | 800 |
| Example 8 | | | | |

### EXPERIMENTAL EXAMPLE

### (1) Measurement of XRD

Composite oxides were obtained from the catalysts prepared in the examples and comparative examples. The X-ray diffraction distributions of the composite oxides were measured.

Specifically, crystal structures of the composite oxides were measured by X-ray diffraction (XRD) analysis under conditions of 300 mA current, 50 kV voltage, wavelength of CuKα (1.5428 Å), 5 degree min⁻¹ scan speed, and 2θ=10° to 80°.

### (2) Measurement of Dispersion

The catalysts prepared in the examples and comparative examples were measured using a carbon monoxide adsorption evaluation device (Micrometrics, ASAP 2020). 0.1 g of catalyst was charged into an adsorption tube, followed by reducing at 300° C. and decreasing the temperature to measure the saturated adsorption amount of carbon monoxide at room temperature. The dispersion was calculated by considering that the adsorbed carbon monoxide molecules were due to combination adsorption with the ruthenium catalyst.

The dispersion (%) was calculated using Equation 2 below.

$$Dispersion ( \% ) = ( Content of active metal exposed to \qquad Equation 2$$

$$surface of catalyst measured by carbon monoxide / Content of active$$

$$metal used in catalyst ) \times 100$$

### (3) Measurement of Decomposition Rate According to Ammonia Conversion Temperature

The exhaust gas after the ammonia decomposition reaction was measured using a gas chromatography (GC) equipped with a thermal conductivity detector (TCD), and the residual ammonia content was obtained from a calibration curve using standard gas (ammonia: Shinheung Industrial Gas, dilution gas: nitrogen), and the decomposition rate was calculated in Equation 3 below.

That is, the ammonia decomposition rate (%) was calculated using Equation 3 below.

$$Ammonia decomposition rate ( \% ) = \qquad Equation 3$$

$$\{ ( Supply ammonia content - Residual ammonia content ) /$$

$$Supply ammonia content \} \times 100.$$

Evaluation results are described in Table 3 below.

TABLE 3

| | Crystal | Dispersion | Ammonia decomposition rate according to temperature (%) | | | |
|---|---|---|---|---|---|---|
| | structure | (%) | 400° C. | 450° C. | 500° C. | 550° C. |
| Example 1 | P | 53.3 | 40 | 70 | 90 | 99 |
| Example 2 | P | 48.3 | 30 | 54 | 80 | 97 |
| Example 3 | P | 32.6 | 44 | 74 | 93 | 98 |
| Example 4 | P + M | 61 | 44 | 71 | 90 | 98 |
| Comparative | P + M | 38.7 | 38 | 69 | 92 | 98 |
| Example 4 | | | | | | |
| Comparative | P + M | 67.5 | 38 | 66 | 90 | 98 |
| Example 5 | | | | | | |
| Comparative | P + M | 25.3 | 53 | 78 | 93 | 98 |
| Example 6 | | | | | | |
| Comparative | P + M | 25.4 | 50 | 75 | 93 | 98 |
| Example 7 | | | | | | |
| Comparative | P + M | 46.6 | 49 | 78 | 93 | 98 |
| Example 8 | | | | | | |

In Table 3 above, P refers to the perovskite, and M refers to the mixed oxide.

Referring to Table 3, the composite oxides of the ammonia decomposition catalysts prepared in Examples 1 to 3 had a crystal structure of perovskite, respectively.

In the case of Examples 1 and 2, even though the ammonia decomposition catalyst included a relatively small amount of ruthenium, the ammonia decomposition rate was maintained high. In the case of Example 1, where the second heat treatment temperature was relatively low, the dispersion was not decreased, such that the ammonia decomposition rate was further improved.

In the case of Example 4, the first heat treatment was performed at a relatively low temperature, such that the composite oxide included a crystal structure in the form of the mixed oxide (M). However, in Example 4, even though the preparation process of the ammonia decomposition catalyst was performed at a relatively low temperature, the first heat treatment was conducted in a reducing gas atmosphere, such that the dispersion and ammonia decomposition rate were improved compared to the comparative examples.

In the case of the comparative examples, the first heat treatment was performed in an ambient atmosphere, and the composite oxide included a mixed oxide structure in the crystal structure. Accordingly, even though the ruthenium content was higher than that of Examples 1 to 4, the ammonia decomposition rate was equivalent or deteriorated at a low dispersion or relatively low temperature.

Therefore, it was confirmed that the ammonia decomposition catalyst according to the embodiments improves the decomposition rate of ammonia despite including a small amount of ruthenium, and also secures high-temperature stability. The overall process cost may also be reduced.

What is claimed is:

1. A method of preparing a catalyst for ammonia decomposition, the method comprising:
performing heat treatment on alumina, a lanthanum compound and a cerium compound in a reducing gas atmosphere to form a composite oxide on an alumina support; and
supporting an active metal including ruthenium on the composite oxide.

2. The method according to claim 1,
wherein the reducing gas atmosphere includes hydrogen, and
wherein the active metal further comprises a promoter including at least one of cesium (Cs), sodium (Na), potassium (K), lithium (Li), rubidium (Rb), francium (Fr), barium (Ba), calcium (Ca), strontium (Sr), beryllium (Be) and magnesium (Mg).

3. The method according to claim 1, wherein forming the composite oxide includes performing a heat treatment on the alumina, the lanthanum compound and the cerium compound at a temperature of greater than 600° C. and 1,000° C. or lower.

4. The method according to claim 3, wherein forming the composite oxide includes performing heat treatment on the alumina, the lanthanum compound and the cerium compound at a temperature of 900° C. to 1,000° C.

5. The method according to claim 1, wherein the reducing gas includes hydrogen in an amount of 10% by volume to 100% by volume based on a total volume of the reducing gas.

6. The method according to claim 1, wherein the composite oxide contains lanthanum, cerium and aluminum.

7. The method according to claim 1, wherein forming the composite oxide includes doping lanthanum derived from the lanthanum compound and cerium derived from the cerium compound on a surface of the alumina.

8. The method according to claim 1, wherein the alumina support includes Al₂O₃.

9. The method according to claim 1, wherein the composite oxide has a perovskite structure.

10. The method according to claim 9, wherein a ratio of the perovskite structure in a crystal structure of the composite oxide is 5% to 99%.

11. The method according to claim 1, wherein supporting the active metal including ruthenium on the composite oxide comprises mixing the composite oxide and the active metal including ruthenium, and performing heat treatment.

12. The method according to claim 11, wherein a heat treatment temperature on the composite oxide and the active metal is lower than a heat treatment temperature on the alumina, the lanthanum compound and the cerium compound.

13. The method according to claim 11, wherein the heat treatment temperature on the composite oxide and the active metal is 200° C. to 1,000° C.

14. The method according to claim 13, wherein the heat treatment temperature on the composite oxide and the active metal is 400° C. to 800° C.

15. The method according to claim 14, wherein the heat treatment temperature on the composite oxide and the active metal is 400° C. to 600° C.

16. The method according to claim 1, wherein supporting an active metal including ruthenium on the composite oxide is performed in a reducing gas atmosphere.

17. The method according to claim 1, wherein a content of ruthenium supported on the composite oxide is less than 1.5% by weight based on a total weight of the composite oxide and the active metal.

18. The method according to claim 1, wherein the content of ruthenium supported on the composite oxide is 0.1% by weight to 1.3% by weight based on the total weight of the composite oxide and the active metal.

19. The method according to claim 1, wherein the lanthanum compound includes lanthanum nitrate, and the cerium compound includes cerium nitrate.

20. The method according to claim 7, wherein the lanthanum and cerium doped on the surface of the alumina have a form of nanoparticles, and the particles have a diameter of 1 nm to 500 nm.

21. A method of making an ammonia decomposition catalyst, the method comprising:
heating alumina, a lanthanum compound and a cerium compound in a reducing gas atmosphere to form a composite oxide on an alumina support; and
supporting an active metal including ruthenium on the composite oxide,
wherein the active metal further comprises a promoter including at least one of cesium (Cs), sodium (Na), potassium (K), lithium (Li), rubidium (Rb), francium (Fr), barium (Ba), calcium (Ca), strontium (Sr), beryllium (Be) and magnesium (Mg), and
wherein forming the composite oxide includes doping lanthanum derived from the lanthanum compound and cerium derived from the cerium compound on a surface of the alumina.
